(19) United States
(12) Patent Application Publication
(10) Pub. No.: US 2003/0132673 A1
(43) Pub. Date: Jul. 17, 2003

(54) Centrifugal liquid cooling system for an electric motor

(76) Inventors: Shijian Zhou, Carmel, IN (US); Andrew T. Hsu, Fishers, IN (US); Yanhu Guo, Indianapolis, IN (US); Linda J. Ludek Brouns, Mc Cordsville, IN (US); John C. Morgante, Noblesville, IN (US)

Correspondence Address: CHRISTOPHER DEVRIES, General Motors Corporation, Legal Staff, Mail Code 482-C23-B21, P.O. Box 300, Detroit, MI, 48265-3000, US

(21) Appl. No.: 10/047,878

(22) Filed: Jan. 17, 2002

(51) Int. Cl. H02K 9/00; H02K 9/20

(52) U.S. Cl. 310/54

(57) ABSTRACT

A method and apparatus for cooling an electric motor including an electric motor having a stator, a rotor magnetically coupled to the stator, and a hollow motor shaft coupled to the rotor, rotating the rotor and the motor shaft, and generating a centrifugal force to force a liquid coolant through the hollow motor shaft.

### TECHNICAL FIELD

The present invention relates to an electric motor. More specifically, the present invention relates to a method and apparatus to cool an electric motor.

### BACKGROUND OF THE INVENTION

An electric motor may be described as generally comprising a stator and a rotor. The stator is fixed in position and the rotor moves relative to the stator. In AC motors, the stator is typically the current-carrying component of the motor generating a magnetic field to interact with the rotor. The rotor in an AC motor may comprise a squirrel cage or a magnetic rotor. The field generated by the stator will propel or rotate the rotor via a magnetic field relative to the stator. In DC motors, the rotor armature is typically the current-carrying component of the motor and is equipped with brushes and slip rings to commutate the current to the rotor. The stator of a DC motor is equipped with a magnetic field generating device such as a permanent magnetic or current carrying coils. The magnetic field generated by the current in the rotor of a DC motor will interact with the magnetic field of the stator to rotate or propel the rotor relative to the stator.

The operation of an electric motor generates heat in the form of current/resistance or I²R losses, iron losses, stray losses, and mechanical losses in the rotor and stator. The stator and rotor are cooled to avoid overheating which would result in the demagnetization of magnets in the motor and the melting or burning of other parts of the motor. Heat dissipation is the limiting factor in motor sizing and power ratings. The motor current is directly related to power output, as well as the heat generated in the motor. In electric motor applications where space is at a premium such as in electric and hybrid electric vehicles, motors with a relatively small footprint and high power rating are desired. Accordingly, the more efficient the removal of heat, the smaller the footprint of a motor for a specific power rating.

Heat from the stator of an electric motor may be removed in relatively simple fashion with cooling jackets, fans, and other cooling devices, but the heat in the rotor is difficult to remove since there is typically an air gap between the rotor and the stator to allow rotor rotation. Air is not an efficient conductor, and the heat transfer from the moving rotor to the stator is relatively inefficient when compared to metal-to-metal or liquid heat conduction. Accordingly, there is a need in the art of electric motors for an efficient method and apparatus to cool the rotor of an electric motor.

### SUMMARY OF THE INVENTION

The present invention is a method and apparatus for cooling an electric motor using a centrifugal flow of coolant such as oil. The electric motor of the present invention includes a hollow shaft having a conically-shaped hollow interior, a first set of passageways through the rotor, and a second set of passageways between the rotor and the hollow shaft. As the rotor and hollow shaft rotate, cooling fluid is forced by centrifugal force through the hollow shaft and the first and second set of passageways. The conical shape of the hollow interior of the rotating shaft creates centrifugal force that moves the cooling fluid through the hollow shaft. The openings in the rotor are at an angle with the rotor axis. The combination of this angle and the rotating motion of the rotor creates a centrifugal force that moves the coolant in the passages.

The speed of the coolant through the hollow shaft, and the first and second set of passageways, can be controlled by choosing the conical angle of the shaft interior, width, and radial location arrangements of the first and second set of passageways. The larger the conical angle of the shaft interior, the higher the flow rate based on a constant speed. A higher radial location of the first and second passageways can generate larger coolant flow rate. The coolant flow through the hollow shaft and first and second set of passageways is also proportional to rotor speed. The higher the speed of the motor, the larger the current flow with a concurrent increase in heat. The cooling system of the present invention is self-regulating, as it automatically adjusts the heat transfer rate to match the motor's heat dissipation requirements. At higher speeds, the motor will generate more heat and the coolant flow through the hollow shaft and first and second passageways will increase. In his manner, the rotor may be cooled by coolant flow.

Cooling the rotor using a coolant flow combined with the conductive heat dissipation at the exterior of the rotor greatly increases the power density that may be provided by an electric motor equipped with the cooling system of the present invention.

### BRIEF DESCRIPTION OF THE DRAWINGS

FIG. 1 is a diagrammatic cut-away drawing illustrating the electric motor of the present invention; and

FIG. 2 is a diagrammatic cut-away drawing of the electric motor rotor of the present invention.

### DESCRIPTION OF THE PREFERRED EMBODIMENT

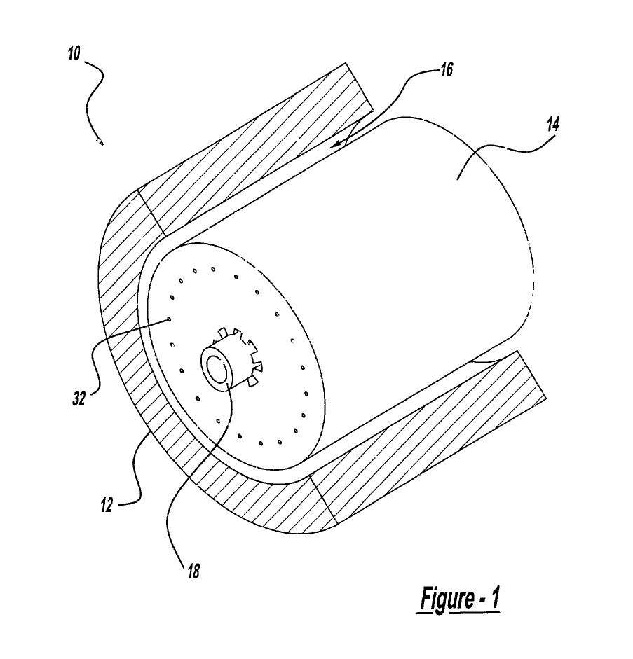

FIG. 1 is a cut-away view of the electric motor 10 of the present invention. The electric motor 10 includes a stator 12 and rotor 14 separated by an air gap 16. In alternate embodiments of the present invention, the air gap may be filled with a cooling fluid 26 to conduct heat from the rotor 14 to the stator 12. The electric motor of the present invention is preferably an AC induction motor with a squirrel cage rotor, but any electric motor technology is considered within the scope of the present invention including, but not limited to, synchronous motors, reluctance motors, DC motors, DC brushless motors, and AC permanent magnet rotor motors. The rotor 14 in the preferred embodiment is an aluminum squirrel cage equipped with steel laminations. The electric motor 10 further includes a hollow motor shaft 18 coupled to the rotor 14. The hollow motor shaft 18 will transfer the rotational motion of the rotor 14 to an external device.

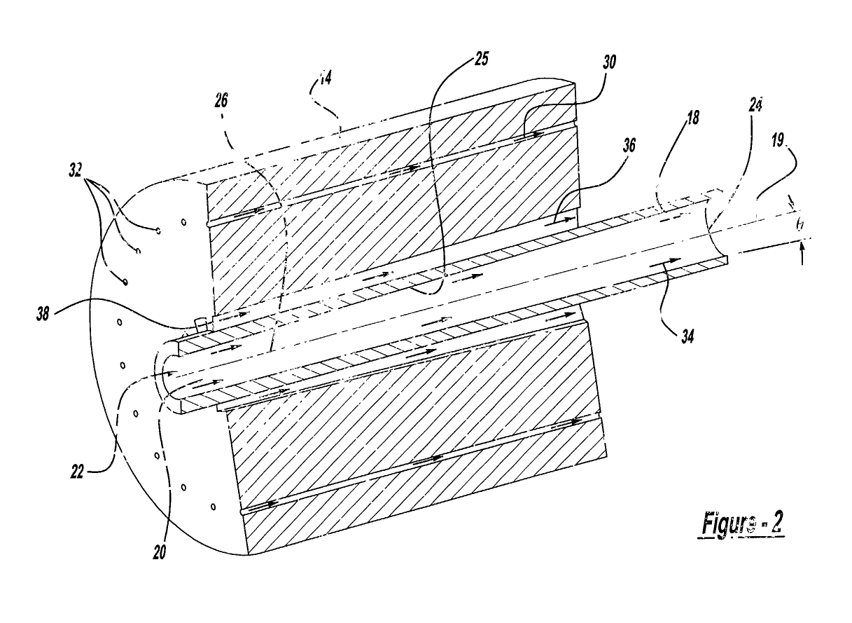

Referring to FIG. 2, a cutaway of the rotor 14 and hollow motor shaft 18 is shown. The hollow shaft 18 includes a conical interior 20. The conical interior is sloped at an angle θ with reference to the motor shaft 18 centerline 19 to form an increasing diameter from a first opening 22 to a second opening 24 of the hollow shaft 18. As the cooling fluid 26 enters the first opening 22, the rotation of the rotor 14 will create a gradient of centrifugal force from the first opening 22 to the second opening 24, forcing a film of the cooling fluid 26 down the length of the hollow shaft 18 along the conical interior 20 of the hollow shaft 18.

Arrows 34 in FIG. 2 illustrate the movement of the cooling fluid 26 film along the conical interior 20 of the hollow shaft 18. A temperature compensation loop is automatically formed for film cooling to make the present invention more robust. The liquid coolant 26 picks up heat and increases in temperature as it moves from the first opening 22 to the second opening 24. The heat reduces the viscosity of the cooling fluid 26 and leads to a decrease in film thickness and an increase in velocity of the liquid coolant 26. These two factors help to increase or retain heat transfer capability during the entire cooling process and result in a more uniform temperature distribution along the axis 19. The cooling fluid 26 will thus conduct heat from the center of the rotor 14, via heat conduction from the shaft 18, to an external heat sink.

The angle θ can be chosen to determine the magnitude of the centrifugal force. The larger the angle 0, the larger the higher the magnitude of the centrifugal force. The magnitude of the liquid coolant 26 film flow and/or velocity is proportional to the rotor 14 speed, creating a self-regulating cooling system. The higher the speed of the rotor 14, the more heat that is generated, but the higher the rate of flow of cooling fluid 26 and heat dissipation.

Referring to FIGS. 1 and 2, an alternate number of heat dissipation mechanisms used in the present invention are further illustrated. Arrows 30 illustrate the conduction of heat through passages 32 in the rotor 14 via the cooling fluid 26. The passages 32 in the preferred embodiment are angled with reference to the centerline 19 of the motor shaft 18 and are equally spaced in radial fashion about the motor shaft 18. The orientation of the passages 32 will generally form a conical shape with the entrance openings of the passages spaced at a first diameter about the centerline 19 of the motor shaft and the exit openings placed at a second diameter about the centerline, the second diameter being greater than the first diameter. In the preferred embodiment, the passages 32 are spaced equidistant from each other. The cooling that occurs in passages 32 may be described as pipe cooling. Pipe cooling is coolant flow where the coolant fills the entire passage.

Arrows 36 illustrate coolant flow between the coolant shaft 18 and the rotor 14, via passages 38. The passages are formed by an internal conical surface of the rotor 14 coupling to the hollow shaft 18. The exterior surface of the hollow shaft 18 is also cone-like in shape to mate with the interior surface of the rotor 14. The rotation of the rotor 14, similar to the previous embodiments, will create a centrifugal force forcing the liquid coolant 26 through the channels 38. Both film- and pipe-type cooling occur in the channels 38.

While this invention has been described in terms of some specific embodiments, it will be appreciated that other forms can readily be adapted by one skilled in the art. Accordingly, the scope of this invention is to be considered limited only by the following claims.

1. An electric motor comprising:
a stator for producing a magnetic field;
a rotor rotated by said magnetic field;
a motor shaft coupled to said rotor;
wherein said motor shaft includes an interior surface that is cone shaped to conduct a liquid coolant through said interior surface to cool the electric motor.

2. The electric motor of claim 1 wherein said stator includes current-carrying coils to generate said magnetic field.

3. The electric motor of claim 1 wherein said rotor is a squirrel cage rotor.

4. The electric motor of claim 1 wherein said rotor includes permanent magnets.

5. The electric motor of claim 1 further including a first set of passageways through said rotor to conduct a liquid coolant.

6. The electric motor of claim 5 wherein said first set of passageways has entrance openings and exit openings, said entrance openings oriented about said motor shaft center line at a first diameter, said exit openings oriented about said motor shaft center line at a second diameter, and said first diameter being less than said second diameter.

7. The electric motor of claim 1 further including a second set of passageways between said rotor and said motor shaft.

8. The electric motor of claim 7 wherein said second set of passageways have entrance openings and exit openings, said entrance openings oriented about said motor shaft center line at a first diameter, said exit openings oriented about said motor shaft center line at a second diameter, and said first diameter being less than said second diameter.

9. An electric motor comprising:
a wound stator, said wound stator conducting current to generate a magnetic field;
a rotor rotated by said magnetic field;
a motor shaft coupled to said rotor, said motor shaft including a cone-shaped interior surface having an entrance opening and an exit opening; and
a liquid coolant propelled by centrifugal force generated by the rotation of said rotor through said cone-shaped interior surface, said liquid coolant cooling the electric motor.

10. The electric motor of claim 9 wherein said rotor is a squirrel cage rotor.

11. The electric motor of claim 9 wherein said rotor includes permanent magnets.

12. The electric motor of claim 9 wherein said liquid coolant is oil.

13. The electric motor of claim 9 further including a first set of passageways through said rotor to conduct said liquid coolant through said rotor.

14. The electric motor of claim 13 wherein said first set of passageways have entrance openings and exit openings, said entrance openings oriented about said motor shaft center line at a first diameter, said exit openings oriented about said motor shaft center line at a second diameter, and said first diameter being less than said second diameter.

15. The electric motor of claim 9 further including a second set of passageways between said rotor and said motor shaft.

16. The electric motor of claim 15 wherein said second set of passageways have entrance openings and exit openings, said entrance openings oriented about said motor shaft center line at a first diameter, said exit openings oriented about said motor shaft center line at a second diameter, and said first diameter being less than said second diameter.

17. A method of cooling an electric motor comprising:
providing an electric motor having a stator, a rotor magnetically coupled to said stator, and a hollow motor shaft coupled to said rotor;
rotating said rotor and said motor shaft; and
generating a centrifugal force to force a liquid coolant through said hollow motor shaft.
